(19) United States
(12) Patent Application Publication
(10) Pub. No.: US 2015/0286571 A1
(43) Pub. Date: Oct. 8, 2015

(54) ADAPTIVE CACHE PREFETCHING BASED ON COMPETING DEDICATED PREFETCH POLICIES IN DEDICATED CACHE SETS TO REDUCE CACHE POLLUTION

(71) Applicant: QUALCOMM Incorporated, San Diego, CA (US)

(72) Inventors: Harold Wade Cain, III, Raleigh, NC (US); David John Palframan, Madison, WI (US)

(73) Assignee: QUALCOMM Incorporated, San Diego, CA (US)

(21) Appl. No.: 14/245,356

(22) Filed: Apr. 4, 2014

(51) Int. Cl. G06F 12/08; G06F 12/12

(52) U.S. Cl. CPC G06F 12/0862; G06F 12/128; G06F 12/0875; G06F 2212/602; G06F 2212/6046; G06F 2212/283

(57) ABSTRACT

Adaptive cache prefetching based on competing dedicated prefetch policies in dedicated cache sets to reduce cache pollution is disclosed. In one aspect, an adaptive cache prefetch circuit is provided for prefetching data into a cache. The adaptive cache prefetch circuit is configured to determine which prefetch policy to use as a replacement policy based on competing dedicated prefetch policies applied to dedicated cache sets in the cache. Each dedicated cache set has an associated dedicated prefetch policy used as a replacement policy for the given dedicated cache set. Cache misses for accesses to each of the dedicated cache sets are tracked by the adaptive cache prefetch circuit. The adaptive cache prefetch circuit can be configured to apply a prefetch policy to the other follower (i.e., non-dedicated) cache sets in the cache using the dedicated prefetch policy that incurred fewer cache misses to its respective dedicated cache sets to reduce cache pollution.

### BACKGROUND

I. Field of the Disclosure

The technology of the disclosure relates generally to cache memory provided in computer systems, and more particularly to prefetching cache lines into cache memory to reduce cache misses.

II. Background

A memory cell is a basic building block of computer data storage, which is also known as “memory.” A computer system may either read data from or write data to memory. Memory can be used to provide cache memory in a central processing unit (CPU) system as an example. Cache memory, which can also be referred to as just “cache,” is a smaller, faster memory that stores copies of data stored at frequently accessed memory addresses in main memory or higher level cache memory to reduce memory access latency. Thus, cache can be used by a CPU to reduce memory access times. For example, cache may be used to store instructions fetched by a CPU for faster instruction execution. As another example, cache may be used to store data to be fetched by a CPU for faster data access.

Cache is comprised of a tag array and a data array. The tag array contains addresses also known as “tags.” The tags provide indexes into data storage locations in the data array. A tag in the tag array and data stored at an index of the tag in the data array is also known as a “cache line” or “cache entry.” If a memory address or portion thereof provided as an index to the cache as part of a memory access request matches a tag in the tag array, this is known as a “cache hit.” A cache hit means that the data in the data array contained at the index of the matching tag contains data corresponding to the requested memory address in main memory and/or a higher level cache. The data contained in the data array at the index of the matching tag can be used for the memory access request, as opposed to having to access main memory or a higher level cache memory having greater memory access latency. If however, the index for the memory access request does not match a tag in the tag array, or if the cache line is otherwise invalid, this is known as a “cache miss.” In a cache miss, the data array is deemed not to contain data that can satisfy the memory access request.

Cache misses in cache are a substantial source of performance degradation for many applications running on a variety of computer systems. To reduce the number of cache misses, computer systems can employ a prefetch engine, also known as a prefetcher. The prefetcher can be configured to detect memory access patterns in the computer system to predict future memory accesses. Using these predictions, the prefetcher will make requests to higher level memory to speculatively preload cache lines into the cache. Thus, when these cache lines are needed, these cache lines are already present in the cache, and no cache miss penalty is incurred as a result.

Although many applications benefit from prefetching, some applications have memory access patterns that are difficult to predict. Enabling prefetching for these applications may significantly reduce performance as a result. In these cases, the prefetcher may request cache lines to be filled in the cache that may never be used by the application. Further, to make room for the prefetched cache lines in the cache, useful cache lines may then be displaced. If the prefetched cache line is not subsequently accessed before a previously displaced cache line is accessed, a cache miss is generated for access to the previously displaced cache line. The cache miss in this scenario was effectively caused by the prefetch operation. The process of displacing a later-accessed cache line with a non-referenced prefetched cache line is referred to as “cache pollution.” Cache pollution can increase cache miss rate, which decreases performance.

Various cache data replacement policies (referred to as “prefetch policies”) exist to attempt to limit cache pollution as a result of prefetching cache lines into cache. For example, one cache prefetch policy tracks various metrics, such as prefetch accuracy, lateness, and pollution level, to dynamically adjust the number of cache lines prefetched by a prefetcher into cache. However, tracking such metrics requires extra hardware overhead in the computer system. For example, a reference bit may be added per cache way in the cache and/or a Bloom filter can be employed in the cache. Another cache prefetch policy replaces only dead cache lines in the cache that have not been accessed in a desired timeframe with prefetched cache data to limit cache pollution. Cache lines that are not dead lines, thus containing useful data, are not evicted from the cache to reduce cache misses. However, this dead line only replacement cache prefetch policy adds hardware overhead to track the timing of accesses to the cache lines in the cache.

Thus, it is desired to provide prefetching of cache data that limits cache pollution in a cache, but without reducing performance benefits of prefetching and incurring substantial additional hardware overhead that can increase power consumption.

### SUMMARY OF THE DISCLOSURE

Aspects disclosed in the detailed description include adaptive cache prefetching based on competing dedicated prefetch policies in dedicated cache sets to reduce cache pollution. In one aspect, an adaptive cache prefetch circuit is provided for prefetching data into a cache. Instead of trying to determine an optimal replacement policy for the cache, the adaptive cache prefetch circuit is configured to determine which prefetch policy to use based on the result of competing dedicated prefetch policies applied to dedicated cache sets in the cache. In this regard, a subset of the cache sets in the cache are allocated as being “dedicated” cache sets. The other non-dedicated cache sets are “follower” cache sets. Each dedicated cache set has an associated dedicated prefetch policy for the given dedicated cache set. Cache misses for accesses to each of the dedicated cache sets are tracked by the adaptive cache prefetch circuit. The adaptive cache prefetch circuit can be configured to apply a prefetch policy to the other follower cache sets in the cache using the dedicated prefetch policy that incurred fewer cache misses to its respective dedicated cache sets. For example, one dedicated prefetch policy may be to never prefetch, and another dedicated prefetch policy may be to always prefetch to provide dueling dedicated prefetch policies for the cache. In this manner, cache pollution may be reduced, because actual cache miss results to dedicated cache sets in the cache may be a better indication of which dedicated prefetch policy will cause less cache pollution in the cache if used as the prefetch policy for the follower cache sets. Reduced cache pollution can result in increased performance, reduced memory contention, and less power consumption by the cache.

In this regard in one aspect, an adaptive cache prefetch circuit for prefetching cache data into a cache is provided. The adaptive cache prefetch circuit comprises a miss tracking circuit configured to update at least one miss state based on a cache miss resulting from an accessed cache entry in: at least one first dedicated cache set in a cache for which at least one first dedicated prefetch policy is applied, and at least one second dedicated cache set in the cache for which at least one second dedicated prefetch policy, different from the at least one first dedicated prefetch policy, is applied. In one example, the miss tracking circuit could provide the at least one miss state as a single miss state to track cache misses for both the at least one first and second dedicated cache sets. As another example, the miss tracking circuit could include separate miss states for each of the at least one first and second dedicated cache sets to separately track cache misses for each of the at least one first and second dedicated cache sets. The adaptive cache prefetch circuit further comprises a prefetch filter. The prefetch filter is configured to select a prefetch policy from among the at least one first dedicated prefetch policy and the at least one second dedicated prefetch policy based on the at least one miss state of the miss tracking circuit.

In another aspect, an adaptive cache prefetch circuit for prefetching cache data into a cache is provided. The adaptive cache prefetch circuit comprises a miss tracking means for updating at least one miss state means based on a cache miss resulting from an accessed cache entry in: at least one first dedicated cache set in a cache for which at least one first dedicated prefetch policy is applied, and at least one second dedicated cache set in the cache for which at least one second dedicated prefetch policy, different from the at least one first dedicated prefetch policy, is applied. The adaptive cache prefetch circuit also comprises a prefetch filter means for selecting a prefetch policy from among the at least one first dedicated prefetch policy and the at least one second dedicated prefetch policy based on the at least one miss state means of the miss tracking means.

In another aspect, a method of adaptive cache prefetching based on competing dedicated prefetch policies in dedicated cache sets is provided. The method comprises receiving a memory access request comprising a memory address to be addressed in a cache. The method also comprises determining if the memory access request is a cache miss by determining if an accessed cache entry among a plurality of cache entries in the cache corresponding to the memory address, is contained in the cache. The method also comprises updating at least one miss state of a miss tracking circuit based on the cache miss resulting from the accessed cache entry in: at least one first dedicated cache set in the cache for which at least one first dedicated prefetch policy is applied, and at least one second dedicated cache set in the cache for which at least one second dedicated prefetch policy, different from the at least one first dedicated prefetch policy, is applied. The method also comprises issuing a prefetch request to prefetch cache data into a cache entry in a follower cache set among a plurality of cache sets in the cache. The method also comprises selecting a prefetch policy from among the at least one first dedicated prefetch policy and the at least one second dedicated prefetch policy, to be applied to the prefetch request, based on the at least one miss state of the miss tracking circuit. The method also comprises filling the prefetched cache data into the cache entry in the follower cache set based on the selected prefetch policy.

In another aspect, a non-transitory computer-readable medium having stored thereon computer executable instructions to cause a processor-based adaptive cache prefetch circuit to prefetch cache data into a cache is provided. The computer executable instructions cause the processor-based adaptive cache prefetch circuit to prefetch the cache data into the cache by updating at least one miss state of a miss tracking circuit based on a cache miss resulting from an accessed cache entry in: at least one first dedicated cache set in a cache for which at least one first dedicated prefetch policy is applied, and at least one second dedicated cache set in the cache for which at least one second dedicated prefetch policy, different from the at least one first dedicated prefetch policy, is applied. The computer executable instructions also cause the processor-based adaptive cache prefetch circuit to prefetch the cache data into the cache by selecting a prefetch policy from among the at least one first dedicated prefetch policy and the at least one second dedicated prefetch policy, to be applied in a prefetch request issued by a prefetch control circuit to cause the cache to be filled, based on the at least one miss state of the miss tracking circuit.

### BRIEF DESCRIPTION OF THE FIGURES

FIG. 1 is a schematic diagram of an exemplary cache memory system that includes a cache and an exemplary adaptive cache prefetch circuit configured to prefetch cache entries based on competing dedicated prefetch policies in dedicated cache sets to reduce cache pollution;

FIG. 2 is a schematic diagram of a data array provided in the cache of the cache memory system in FIG. 1, wherein the cache is comprised of a plurality of follower cache sets and a plurality of dedicated cache sets each associated with a dedicated prefetch policy used to prefetch cache data into a respective dedicated cache set;

FIG. 3A is a flowchart illustrating an exemplary process for updating a miss state(s) in a miss tracking circuit based on if a cache miss occurs when a dedicated cache set in the cache, for which a given dedicated prefetch policy was applied, is accessed;

FIG. 3B is a flowchart illustrating an exemplary process for adaptive cache prefetching using a selected prefetch policy among dedicated prefetch policies used for prefetching to dedicated cache sets, to prefetch data into follower cache sets based on a miss state(s) of a miss indicator(s) tracking competition between the dedicated cache sets;

FIG. 4 is a graph illustrating an exemplary prefetching performance to the cache in the cache memory system in FIG. 1, when adaptive cache prefetching based on competing dedicated prefetch policies in dedicated cache sets is provided;

FIG. 5 is a schematic diagram of an exemplary alternative cache memory system that includes a cache, a cache controller configured to control accesses to the cache, and an exemplary prefetch filter provided within the cache controller and configured to apply a prefetch policy to prefetched cache entries based on competing dedicated prefetch policies used to prefetch data into dedicated cache sets to reduce cache pollution;

FIG. 6A is a schematic diagram of an exemplary cache that can be provided in the cache memory system in FIG. 5, wherein the cache is comprised of a plurality of follower cache sets and a plurality of dedicated cache sets each having an associated dedicated prefetch policy for the given dedicated cache set;

FIG. 6B is a schematic diagram of an exemplary, alternative miss counter configured to update a plurality of miss counts based on cache misses to each dedicated cache set in the cache in FIG. 5; and

FIG. 7 is a block diagram of an exemplary processor-based system that can include the cache memory system in FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include adaptive cache prefetching based on competing dedicated prefetch policies in dedicated cache sets to reduce cache pollution. In one aspect, an adaptive cache prefetch circuit is provided for prefetching data into a cache. Instead of trying to determine an optimal replacement policy for the cache, the adaptive cache prefetch circuit is configured to determine a prefetch policy based on the result of competing dedicated prefetch policies applied to dedicated cache sets in the cache. In this regard, a subset of the cache sets in the cache are allocated as being “dedicated” cache sets. The other non-dedicated cache sets are “follower” cache sets. Each dedicated cache set has an associated dedicated prefetch policy for the given dedicated cache set. Cache misses for accesses to each of the dedicated cache sets are tracked by the adaptive cache prefetch circuit. The adaptive cache prefetch circuit can be configured to apply a prefetch policy to the other follower cache sets in the cache using the dedicated prefetch policy that incurred fewer cache misses to its respective dedicated cache sets. For example, one dedicated prefetch policy may be to never prefetch, and another dedicated prefetch policy may be to always prefetch to provide dueling dedicated prefetch policies for the cache. In this manner, cache pollution may be reduced, because actual cache miss results to dedicated cache sets in the cache may be a better indication of which prefetch policy will cause less cache pollution in the cache if used as the prefetch policy for the follower cache sets. Reduced cache pollution can result in increased performance, reduced memory contention, and less power consumption by the cache.

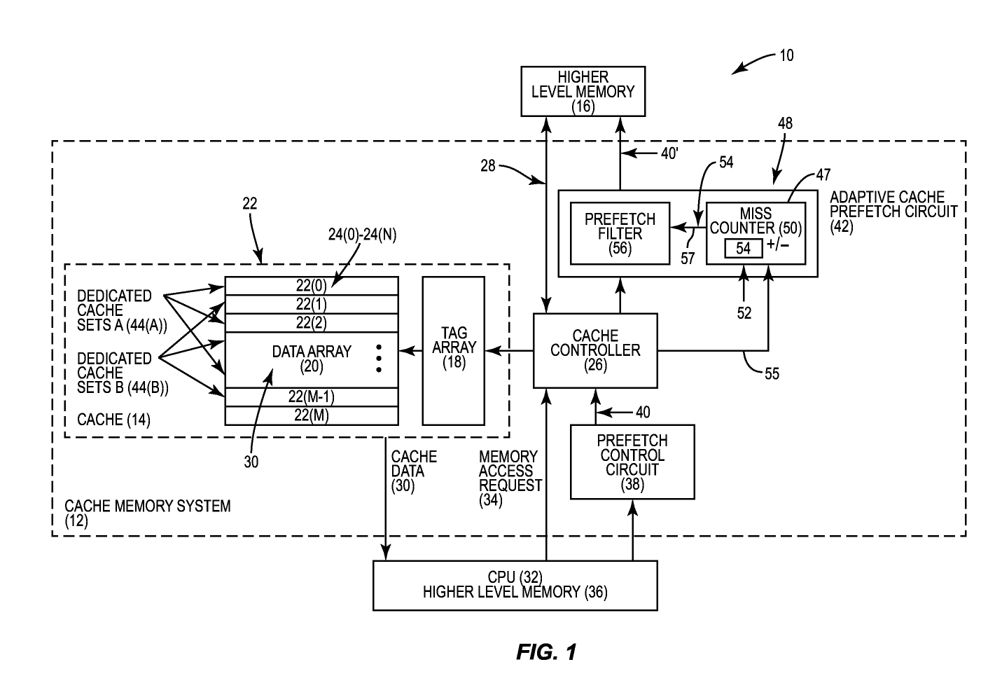

In this regard, FIG. 1 is an exemplary computer system 10 that includes an exemplary cache memory system 12. Before discussing adaptive cache prefetch filtering employed in the cache memory system 12 based on competing dedicated prefetch policies in dedicated cache sets, the exemplary cache memory system 12 is first described.

In this regard, the cache memory system 12 in FIG. 1 includes a cache 14. The cache 14 is a memory configured to store cached data loaded into the cache 14 from a higher level memory 16. As examples, the higher level memory 16 may be a higher level cache or main memory. In this example, the cache 14 is a set-associative cache. The cache 14 comprises a tag array 18 and a data array 20. The data array 20 contains a plurality of cache sets 22(0)-22(M), where ‘M+1’ is equal to the number of cache sets 22. As one example, 1,024 cache sets 22(0)-22(1023) may be provided in the data array 20. Each of the plurality of cache sets 22(0)-22(M) is configured to store cache data in one or more cache entries 24(0)-24(N), wherein ‘N+1’ is equal to the number of cache entries 24 per cache set 22. A cache controller 26 is also provided in the cache memory system 12. The cache controller 26 is configured to fill cache data from the higher level memory 16 into the data array 20. For example, the cache controller 26 is configured to receive data 28 corresponding to data stored at a given memory address from the higher level memory 16 to be stored in the data array 20. The received data 28 is stored as cache data 30 in the cache entry 24(0)-24(N) in the data array 20 according to the memory address. In this manner, a central processing unit (CPU) 32 can access the cache data 30 stored in the cache 14 as opposed to having to obtain the cache data 30 from the higher level memory 16.

With continuing reference to FIG. 1, the cache controller 26 is also configured to receive a memory access request 34 from the CPU 32 or a lower level memory 36. The cache controller 26 indexes the tag array 18 in the cache 14 using the memory address in the memory access request 34. If the tag stored at the index in the tag array 18 indexed by the memory address matches the memory address in the memory access request 34, and the tag is valid, a cache hit occurs. This means that the cache data 30 corresponding to the memory address of the memory access request 34 is contained in a cache entry 24(0)-24(N) in the data array 20. In response, the cache controller 26 causes the indexed cache data 30 corresponding to the memory address of the memory access request 34 to be provided back to the CPU 32 or the lower level memory 36. If a cache miss occurs, the cache controller 26 does not provide the cache data 30 to the CPU 32 or the lower level memory 36.

Cache misses that occur in the cache 14 are a source of performance degradation of the cache memory system 12. To reduce the number of cache misses in the cache memory system 12, a prefetch control circuit 38 is provided in the cache memory system 12. The prefetch control circuit 38 can be configured to detect memory access patterns by the CPU 32 or the lower level memory 36 to predict future memory accesses. Using these predictions, the prefetch control circuit 38 can make a prefetch request 40 based on a prefetch (i.e., replacement) policy to the cache controller 26 to speculatively preload cache data into cache entries 24(0)-24(N) in the cache 14 to replace existing cache data stored in the cache entries 24(0)-24(N). Thus, when the cache data speculatively predicted to be needed in the near future is requested, the cache data is already present in a cache entry 24(0)-24(N) in the cache 14. Thus, no cache miss penalty is incurred as a result. However, prefetching cache data into the cache 14 can also cause cache pollution if the replaced cache data in the cache 14 is needed before the prefetched cache data.

Instead of trying to determine an optimal prefetch policy for the cache 14 in FIG. 1, an adaptive cache prefetch circuit 42 is provided in the cache memory system 12. As will be discussed in more detail below, the adaptive cache prefetch circuit 42 is configured to determine which prefetch policy to use based on the result of competing dedicated prefetch policies applied to dedicated cache sets in the cache 14.

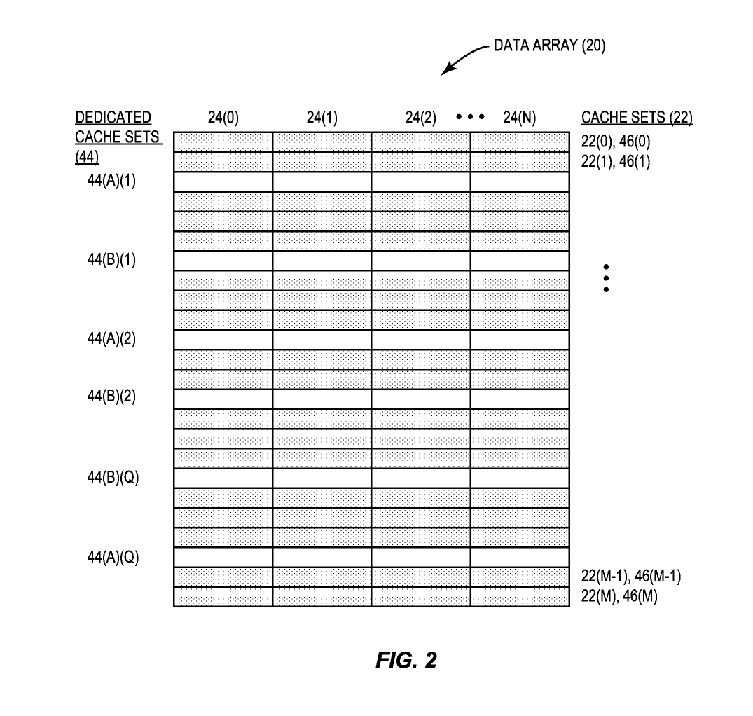

In this regard, FIG. 2 illustrates the data array 20 provided in the cache 14 of the cache memory system 12 in FIG. 1. As illustrated therein, the data array 20 includes the plurality of cache sets 22(0)-22(M). However, a certain subset of the cache sets 22(0)-22(M) in the data array 20 are designated as dedicated cache sets 44. In this example, certain cache sets among the cache sets 22(0)-22(M) are designated as dedicated cache sets 44(A). The notation (A) designates that a first dedicated prefetch policy A is used by the cache controller 26 to prefetch data 28 as cache data 30 into the dedicated cache sets 44(A). Other cache sets among the cache sets 22(0)-22(M) are designated as dedicated cache sets 44(B). The notation (B) designates that a second dedicated prefetch policy B, different from the first dedicated prefetch policy A, is used by the cache controller 26 to prefetch data 28 as cache data 30 into the dedicated cache sets 44(B). The other non-dedicated cache sets among the cache sets 22(0)-22(M) are designated as follower cache sets 46. Cache misses for accesses to each of the dedicated cache sets 44(A), 44(B) are tracked by the adaptive cache prefetch circuit 42. The adaptive cache prefetch circuit 42 is configured to apply a prefetch policy to the other follower cache sets 46 among the cache sets 22(0)-22(M) using the dedicated prefetch policy A or B that caused the dedicated cache sets 44(A), 44(B) to incur fewer cache misses when accessed. In other words, the dedicated cache sets 44(A), 44(B) in the data array 20 in FIG. 2 are set in competition with each other. In this manner, cache pollution may be reduced, because actual cache miss results associated with each of the dedicated cache sets 44(A), 44(B) that were prefetched with their respective dedicated prefetch policy A or B may be a better indication of which prefetch policy will cause less cache pollution in the cache 14 if used as the prefetch policy for the follower cache sets 46 among the cache sets 22(0)-22(M). Reduced cache pollution can result in increased performance, reduced memory contention, and less power consumption by the cache 14 in the cache memory system 12.

As will be discussed in more detail below with regard to FIGS. 1 and 2, cache misses that result from accesses to cache entries 24(0)-24(N) in the dedicated cache sets 44(A), 44(B) are tracked in a miss tracking circuit 47 in the cache memory system 12 in FIG. 1. In this example, the miss tracking circuit 47 is configured to track cache misses that occur from accesses to the dedicated cache sets 44(A), 44(B) to determine a prefetch policy. The miss tracking circuit 47 in this example includes a miss indicator 48 provided in the form of a miss counter 50. The miss counter 50 is configured to track cache misses that occur from accesses to the dedicated cache sets 44(A), 44(B) based on a miss state 52. The miss state 52 is provided in the form of a miss count 54 in this example. In this example, the miss counter 50 is a single miss saturation counter. However, in other aspects discussed below, a separate miss counter 50 could be provided for each of the dedicated cache sets 44(A), 44(B) to separately track cache misses to each of the dedicated cache sets 44(A), 44(B). The miss counter 50 in FIG. 1 is configured to update the miss count 54 based on a cache miss reported by the cache controller 26 over a cache hit/miss line 55 resulting from an accessed cache entry 24(0)-24(N) in a first dedicated cache set 44(A), for which the first dedicated prefetch policy A is applied. The miss counter 50 is also configured to update the miss count 54 based on a cache miss resulting from an accessed cache entry 24(0)-24(N) in a second dedicated cache set 44(B), for which the second dedicated prefetch policy B is applied.

With continuing reference to FIG. 1, a prefetch filter 56 provided in the adaptive cache prefetch circuit 42 is configured to select a prefetch policy from among the first dedicated prefetch policy A and the second dedicated prefetch policy B based on the miss count 54 of the miss counter 50. In this example, the miss counter 50 is a miss saturation counter that is configured to increment when a cache miss occurs for an access to one of the dedicated cache sets 44(A), 44(B), and decrement when a cache miss occurs for access to the other one of the dedicated cache sets 44(B), 44(A), or vice versa. Providing a miss saturation counter as the miss counter 50 may be a lower cost alternative to providing a separate miss counter for each of the dedicated cache sets 44(A), 44(B), although providing a separate miss counter for each of the dedicated cache sets 44(A), 44(B) is possible and contemplated herein as an option. The miss counter 50 tracks which dedicated cache sets 44(A), 44(B) incur fewer cache misses when accessed over time. The prefetch filter 56 receives the miss counter 50 over a miss count line 57 to select the dedicated prefetch policy A or B corresponding to the dedicated cache sets 44(A), 44(B) which incurred fewer cache misses to be used as the prefetch policy for the follower cache sets 46. In this example, the prefetch filter 56 receives the prefetch request 40 from the cache controller 26. The prefetch filter 56 applies the selected dedicated prefetch policy A or B based on the miss counter 50 to the prefetch request 40 received from the cache controller 26 as prefetch request 40′.

In this example, since there are only two (2) dedicated prefetch policies A and B employed in the data array 20 in FIGS. 1 and 2, the dedicated cache sets 44(A), 44(B) in the data array 20 in FIG. 2 can be said to be dueling dedicated cache sets. However, note that more than two (2) types of dedicated cache sets 44 each designated with a dedicated prefetch policy can be provided to allow the prefetch filter 56 to select from more than two (2) dedicated prefetch policies. In FIG. 2, there are ‘Q’ number of dedicated cache sets 44(A)(1)-44(A)(Q) associated with prefetch policy A, and ‘Q’ number of dedicated cache sets 44(B)(1)-44(B)(Q) associated with prefetch policy B shown in the data array 20. For example, if the data array 20 in FIG. 2 contained 1,024 cache sets 22 (i.e., 22(0)-22(M), where ‘M’ is equal to 1023), thirty (32) of the cache sets 22(0)-22(1023) may be designated as dedicated cache sets 44(A), and thirty (32) of the cache sets 22(0)-22(1023) may be designated as dedicated cache sets 44(B). In this example, ‘Q’ would equal thirty-two (32). This would leave nine hundred sixty (960) of the cache sets 22(0)-22(M) as follower cache sets 46. Note that it is not required for the same number of dedicated cache sets 44 to be dedicated to each dedicated prefetch policy A and B.

Designating a greater number of the cache sets 22(0)-22(M) in the data array 20 as dedicated caches sets 44 may provide for the competing dedicated prefetch policies A and B to be updated more often, because accesses to the respective dedicated cache sets 44(A), 44(B) may occur more often. However, designating a greater number of the cache sets 22(0)-22(M) in the data array 20 designated as dedicated caches sets 44 also limits the number of follower cache sets 46 among the cache sets 22(0)-22(M) in which the competing prefetch policy A or B can be applied. The number of cache sets 22(0)-22(M) selected as dedicated cache sets 44(A), 44(B), as well as the location of the dedicated cache sets 44(A) and 44(B) within the data array 20, can be selected based on design considerations, such as sampling to probabilisticly determine a distribution of accesses to the cache sets 22(0)-22(M) in the data array 20.

Further, the dedicated prefetch polices A and B may be provided as any prefetch policies desired, as long as prefetch polices A and B are different prefetch policies. Otherwise, the same prefetch policy would be applied to the follower cache sets 46, which would not have a chance to reduce cache pollution over using a single prefetch policy for all the cache sets 22(0)-22(M) without employing the adaptive cache prefetch circuit 42. For example, prefetch policy A used to prefetch data 28 into the dedicated cache sets 44(A)(1)-44(A)(Q) may be to never prefetch, whereas prefetch policy B may be to always prefetch data 28 into the dedicated cache sets 44(B)(1)-44(B)(Q).

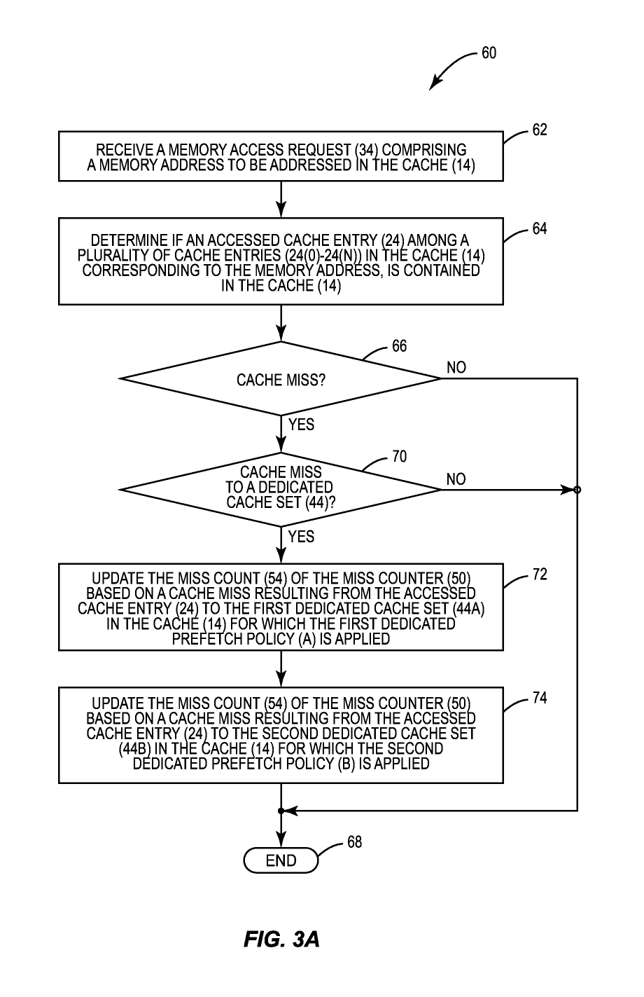

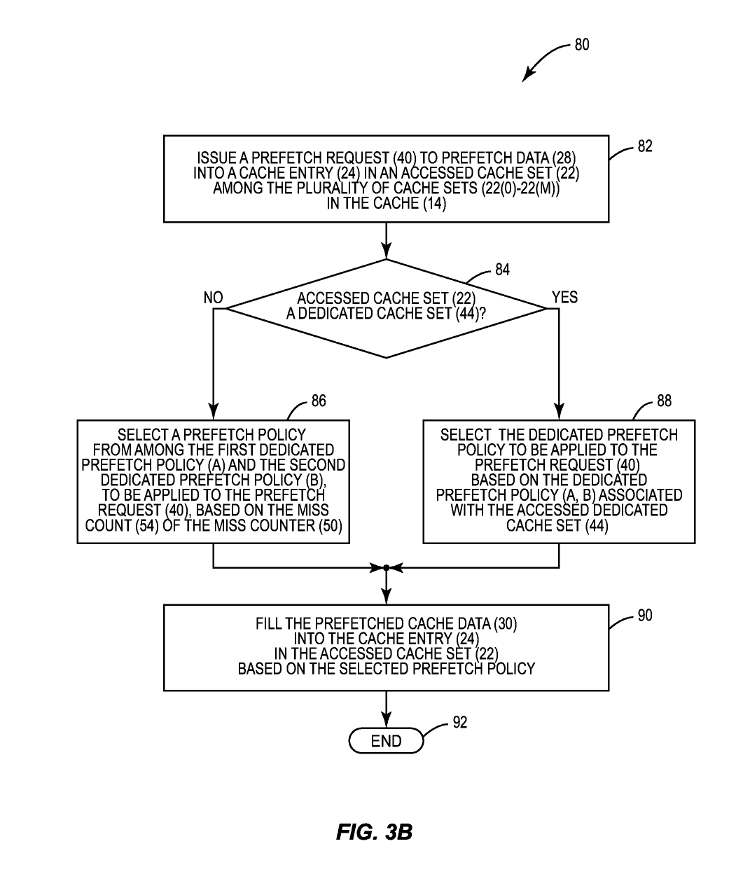

To further explain the adaptive prefetching performed on the cache memory system 12 of FIG. 1 based on competing dedicated prefetch policies in the dedicated cache sets 44(A), 44(B), FIGS. 3A and 3B are provided. FIG. 3A is a flowchart of an exemplary process 60 for updating the miss count 54 of the miss counter 50 based on if a cache miss occurs when a dedicated cache set 44(A), 44(B) in the cache 14 is accessed to track the competition of the dedicated cache set 44(A), 44(B). FIG. 3B is a flowchart of an exemplary process 80 for adaptive cache prefetching using a selected prefetch policy among the dedicated prefetch policies A, B, to prefetch data 28 into follower cache sets 46 in the cache 14 based on the miss count 54 of the miss counter 50 tracking the competition between the dedicated cache sets 44(A), 44(B). Both processes 60, 80 will be described in reference to the cache memory system 12 in FIG. 1.

With reference to FIG. 3A, the cache controller 26 of the cache 14 receives the memory access request 34 comprising a memory address to be addressed in the cache 14 (block 62). The cache controller 26 consults the tag array 18 to determine if the accessed cache entry 24 among the cache entries 24(0)-24(N) in the cache 14 corresponding to the memory address of the memory access request 34 is contained in the data array 20 of the cache 14 (block 64). If the memory address of the memory access request 34 is contained in the data array 20 of the cache 14, meaning a cache hit has occurred (decision 66), the miss count 54 of the miss counter 50 is not updated (block 66) and the process ends (block 68). However, if the memory access request 34 is not contained in the data array 20 of the cache 14 (decision 66), meaning a cache miss has occurred, the cache controller 26 communicates the cache miss to the adaptive cache prefetch circuit 42. If the cache miss is to a dedicated cache set 44(A) or 44(B) (decision 70), the miss count 54 of the miss counter 50 is updated based on the cache miss resulting from the accessed cache entry 24 to a dedicated cache set 44(A), 44(B) (block 72, 74), and the process ends (block 68). For example, the miss count 54 of the miss counter 50 may be incremented if a cache miss resulting from the accessed cache entry 24 occurred in dedicated cache set 44(A), and decremented if a cache miss resulting from the accessed cache entry 24 occurred in dedicated cache set 44(B). Thus, this exemplary process 60 in FIG. 3A maintains the miss count 54 of the miss counter 50 to track the completion of cache misses to the dedicated cache set 44(B). If the cache miss is not to a dedicated cache set 44(A) or 44(B) (decision 70), the miss count 54 is not updated and the process ends (block 68).

As discussed above, the process 80 in FIG. 3B is used to prefetch data 28 into the cache 14 using the selected prefetch policy among the dedicated prefetch policies A, B associated with the dedicated cache set 44(A), 44(B) based on the miss count 54 of the miss counter 50. In this regard, a prefetch request 40 is issued by the CPU 32 or the lower level memory 36 to prefetch data 28 into a cache entry 24 in an accessed cache set 22 among the cache sets 22(0)-22(M) in the cache 14 (block 82). The prefetch filter 56 of the adaptive cache prefetch circuit 42 determines if the accessed cache set 22 is a dedicated cache set 44(A), 44(B) (decision 84) based on information received from the cache controller 26. If the accessed cache set 22 is a dedicated cache set 44(A), 44(B) (decision 84), the prefetch policy applied by the prefetch filter 56 is the respective dedicated prefetch policy A or B associated with the particular dedicated cache set 44(A), 44(B) accessed (block 88). However, if the accessed cache set 22 is not a dedicated cache set 44(A), 44(B) (decision 84), but instead a follower cache set 46, the prefetch filter 56 selects a prefetch policy from among the dedicated prefetch policies A or B to be applied to the prefetch request 40 based on the miss count 54 of the miss counter 50 (block 86). For example, if the miss count 54 indicates that dedicated cache set 44(A) incurred fewer cache misses when accessed than dedicated cache set 44(B), the prefetch filter 56 may select prefetch policy A to be used for the prefetch request 40 to the follower cache set 46. Also, in block 86 as an additional or alternative feature, the prefetch filter 56 of the cache prefetch circuit 42 could also be controlled to probabilistically determine if the first dedicated prefetch policy A of the second dedicated prefetch policy B should be applied to the prefetch request 40 based on the miss count. In either case, whether the accessed cache set 22 is a dedicated cache set 44(A), 44(B) or a follower cache set 46, the selected prefetch policy applied by the prefetch filter 56 is used to fill the prefetched cache data 30 into the cache entry 24 of the accessed cache set 22 (block 90), and the process ends (block 92).

As discussed above, rather than applying the miss count 54 to a fixed threshold to bimodally choose dedicated prefetch policy A or dedicated prefetch policy B, the miss count 54 can be used to control a probability that will select whether to use dedicated prefetch policy A or dedicated prefetch policy B based on the magnitude of the miss count 54. For example, a large value of the miss count 54 may be used to indicate a high probability of choosing dedicated prefetch policy A (and conversely, a low probability of choosing dedicated prefetch policy B). A small value of the miss count 54 may be used to indicate a low probability of choosing dedicated prefetch policy A (and conversely, of a high probability of dedicated prefetch policy B). As an example, such a probabilistic function can be implemented by generating a random integer to be compared to the miss count 54. For example, if the miss count 54 is implemented using a six (6) bit counter, a random 6-bit integer is generated, and compared to the miss count 54. If the miss count 54 is less than or equal to the randomly generated integer, then dedicated prefetch policy A is used; otherwise dedicated prefetch policy B is used.

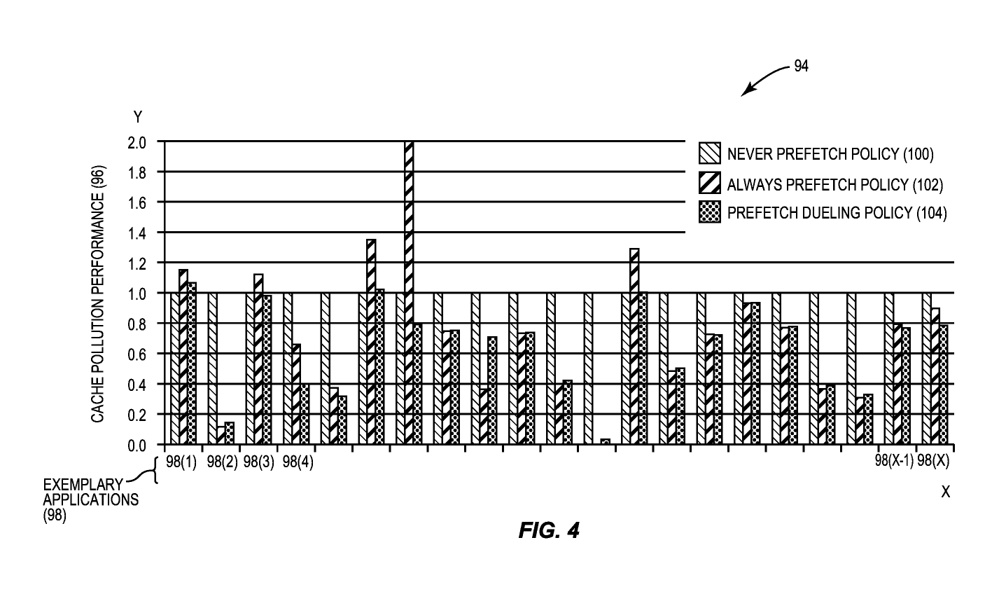

FIG. 4 is a graph 94 illustrating an exemplary prefetching performance to the cache 14 of the cache memory system 12 in FIG. 1, when the adaptive cache prefetching is performed by the adaptive cache prefetch circuit 42. In this regard, cache pollution 96 is show on the Y-axis. A higher level of the cache pollution 96 is shown by a higher amplitude on the Y-axis of the graph 94. The cache pollution 96 is benchmarked for exemplary applications 98(1)-98(X), as shown on the X-axis using a never prefetch policy 100 only, an always prefetch policy 102 only, and a prefetch dueling policy 104 as provided by the adaptive cache prefetch circuit 42 discussed above. As shown, the cache pollution 96 employing the prefetch dueling policy 104 as provided by the adaptive cache prefetch circuit 42 results in less cache pollution 96 (i.e., lower amplitude cache pollution 96) for most applications 98(1)-98(X) versus using the never prefetch policy 100 only or the always prefetch policy 102 only.

Further, note that operation of the adaptive cache prefetch circuit 42 in FIG. 1, in the exemplary processes in FIGS. 3A and 3B, can be configured to selectively disabled. For example, the adaptive cache prefetch circuit 42 in FIG. 1, could be configured to not select a prefetch policy from among the first dedicated prefetch policy A and the second dedicated prefetch policy B in block 86 in FIG. 3B. Instead, a default prefetch policy or prefetch policy provided for or associated with the prefetch request 40 would be used for prefetching data 28 to a follower cache set 46. For example, the enable/disable feature could be controlled based a bit in the miss count 54 be designated as an enable/disable bit. For example, a most significant bit in the miss count 54 could be designated as the adaptive cache prefetch enable/disable bit. The miss counter 50 could be configured to set the enable/disable bit in the miss count 54 based on an instruction from the cache controller 26. The adaptive cache prefetch circuit 42 could be configured to review that enable/disable bit as part of receiving the miss count 54 from the miss counter 50 to determine if the prefetch filter 56 should apply a dedicated prefetch policy to the prefetch request 40 based on the miss count 54. Similarly, an indicator could be provided in the adaptive cache prefetch circuit 42 to indicate that the prefetch filter 54 should not use one of the dedicated prefetch policies A, B, if desired.

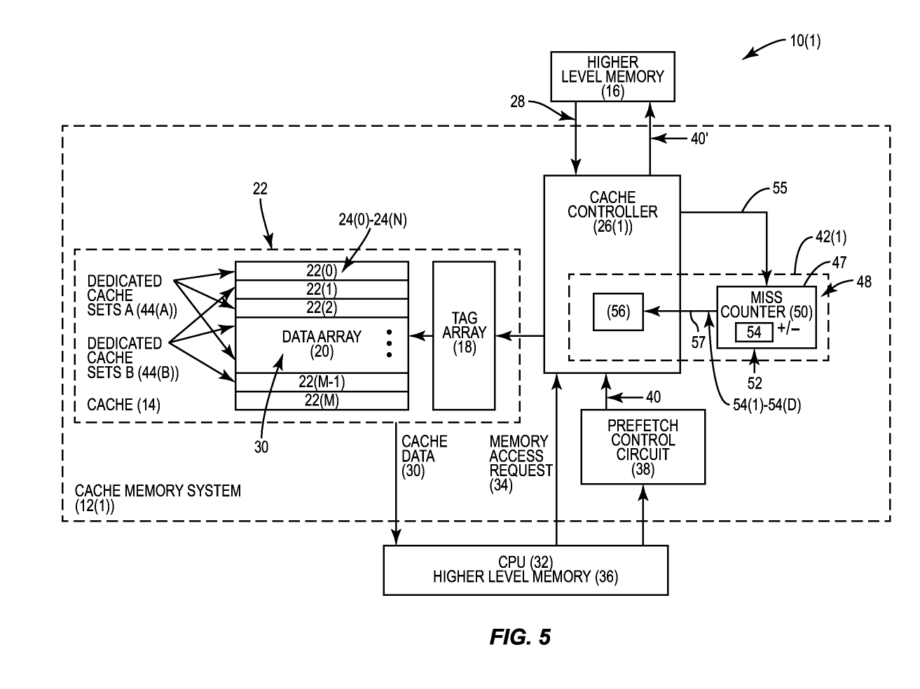

In FIG. 1, the adaptive cache prefetch circuit 42 is provided outside of the cache controller 26 in the cache memory system 12. As discussed above, the adaptive cache prefetch circuit 42 receives the prefetch request 40 to apply the selected prefetch policy among the dedicated prefetch policies A or B for prefetches to follower cache sets 46 among the cache sets 22(0)-22(M). However, the functionality of the adaptive cache prefetch circuit 42 in FIG. 1 could also be provided within or built in to the cache controller 26. Further, the miss tracking circuit 47 could also be provided within the cache controller 26. In this regard, FIG. 5 illustrates an alternative computer system 10(1) that includes an alternative cache memory system 12(1). Components that are common between the cache memory system 12 in FIG. 1 and the cache memory system 12(1) in FIG. 5 are shown with common element numbers, and thus will not be re-described here. An alternative cache controller 26(1) is provided that includes the functionality of the adaptive cache prefetch circuit 42 in FIG. 1 in this aspect. The miss counter 50 is provided that is shown outside of the cache controller 26(1); however, the miss counter 50 could also be included within the cache controller 26(1).

Further, note that although the cache sets 22 among the plurality of cache sets 22(0)-22(M) in the data array 20 in FIGS. 1 and 2 discussed above were designated as dedicated cache sets 44(A), 44(B), and where the miss counter 50 was a miss saturation counter, such is not limiting. For example, more than two (2) types of cache sets 22 among the plurality of cache sets 22(0)-22(M) in the data array 20 may be designated as dedicated cache sets 44. This may be desired to provide more than two (2) dedicated prefetch policies that can be applied by the adaptive cache prefetch circuit 42. In this case, multiple miss counters may be provided to separately track cache misses to each of the more than two (2) dedicated cache sets 44, instead of using a single miss counter 50 as provided in the cache memory systems 12, 12(1) in FIGS. 1 and 5, respectively.

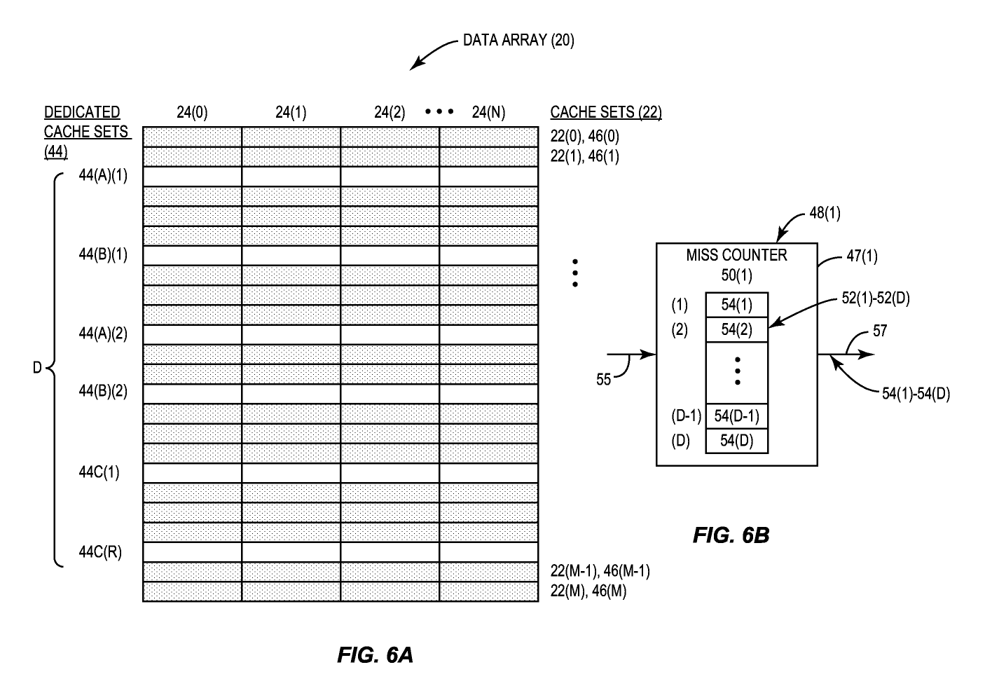

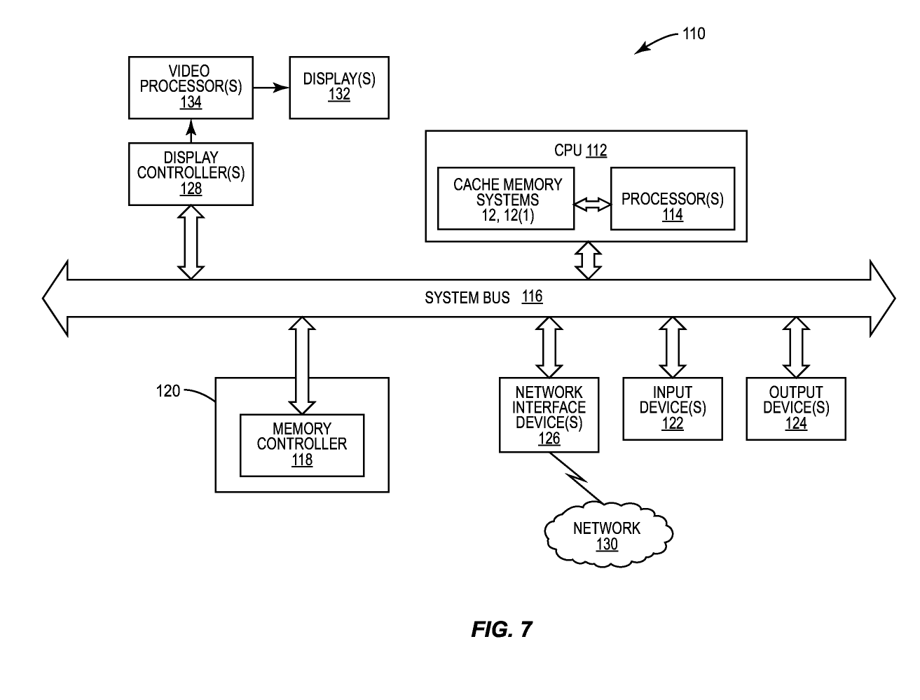

In this regard, FIG. 6A is a diagram of the data array 20 in the cache memory systems 12, 12(1), with more than two (2) types of dedicated cache sets 44. In the data array 20 in FIG. 6A, there are three (3) types of dedicated cache sets 44(A), 44(B), and 44(C), wherein a dedicated prefetch policy A, B, and C is associated with each of the dedicated cache sets 44(A), 44(B), 44(C), respectively. Further, the number of cache sets 22 designated within a dedicated cache set 44 can vary. For example, dedicated cache sets 44(A), 44(B) each include ‘Q’ number of cache sets 22 (i.e., 44(A)(1)-44(A)(Q) and 44(B)(1)-44(B)(Q)). However, dedicated cache set 44(C) includes ‘R’ number of cache sets 22 (i.e., 44(C)(1)-44(C)(R)). In this manner, the adaptive cache prefetch circuit 42 can apply any of dedicated prefetch policy A, B, or C for prefetching to the follower cache sets 46 among the cache sets 22(0)-22(M) based on the competition of tracked cache misses to the dedicated cache sets 44(A), 44(B), and 44(C).

FIG. 6B illustrates an alternative miss tracking circuit 47(1) that has an alternative miss indicator 48(1) in the form of an alternative miss counter 50(1). The miss counter 50(1) is configured to track the cache misses to the dedicated cache sets 44(A), 44(B), and 44(C) in FIG. 6A. In this aspect, because there are not only two (2) types of dedicated cache sets 44(A), 44(B), additional miss counters are needed to track a miss count 54(1) for each competing dedicated cache set 44(A), 44(B), 44(C). In this regard, the miss counter 50(1) is comprised of a plurality of miss counts 54(1)-54(D), where ‘D’ is the total number of cache sets 22 among the cache sets 22(0)-22(M) that are provided as dedicated cache sets 44(A), 44(B), 44(C) in the data array 20 in FIG. 6A. In this manner, the prefetch filter 56 can compare each of the miss counts 54(1)-54(D) in the miss counter 50(1) to determine which dedicated prefetch policy among the dedicated prefetch policies A, B, and C to use to prefetch the data 28 into the follower cache sets 46 of the data array 20.

The adapted cache prefetch circuits and/or cache memory systems according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

In this regard, FIG. 7 illustrates an example of a processor-based system 110 that can employ the cache memory systems 12, 12(1) and/or the adaptive cache prefetch circuits 42, 42(1) in FIGS. 1 and 5. In this example, the processor-based system 110 includes one or more CPUs 112, each including one or more processors 114. The CPU(s) 112 may be a master device. The CPU(s) 112 can include the cache memory system 12 or 12(1) coupled to the processor(s) 114 for rapid access to temporarily stored data. The CPU(s) 112 is coupled to a system bus 116 and can intercouple master and slave devices included in the processor-based system 110. As is well known, the CPU(s) 112 communicates with these other devices by exchanging address, control, and data information over the system bus 116. For example, the CPU(s) 112 can communicate bus transaction requests to a memory controller 118 as an example of a slave device. Although not illustrated in FIG. 7, multiple system buses 116 could be provided, wherein each system bus 116 constitutes a different fabric.

Other master and slave devices can be connected to the system bus 116. As illustrated in FIG. 7, these devices can include a memory system 120, one or more input devices 122, one or more output devices 124, one or more network interface devices 126, and one or more display controllers 128, as examples. The input device(s) 122 can include any type of input device, including but not limited to input keys, switches, voice processors, etc. The output device(s) 124 can include any type of output device, including but not limited to audio, video, other visual indicators, etc. The network interface device(s) 126 can be any devices configured to allow exchange of data to and from a network 130. The network 130 can be any type of network, including but not limited to a wired or wireless network, a private or public network, a local area network (LAN), a wide local area network (WLAN), and the Internet. The network interface device(s) 126 can be configured to support any type of communications protocol desired.

The CPU(s) 112 may also be configured to access the display controller(s) 128 over the system bus 116 to control information sent to one or more displays 132. The display controller(s) 128 sends information to the display(s) 132 to be displayed via one or more video processors 134, which process the information to be displayed into a format suitable for the display(s) 132. The display(s) 132 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An adaptive cache prefetch circuit for prefetching cache data into a cache, comprising:
a miss tracking circuit configured to update at least one miss state based on a cache miss resulting from an accessed cache entry in: at least one first dedicated cache set in a cache for which at least one first dedicated prefetch policy is applied, and at least one second dedicated cache set in the cache for which at least one second dedicated prefetch policy, different from the at least one first dedicated prefetch policy, is applied; and
a prefetch filter configured to select a prefetch policy from among the at least one first dedicated prefetch policy and the at least one second dedicated prefetch policy based on the at least one miss state of the miss tracking circuit.

2. The adaptive cache prefetch circuit of claim 1, wherein the prefetch filter is further configured to select the prefetch policy to be applied to a prefetch request issued by a prefetch control circuit to cause the cache to be filled.

3. The adaptive cache prefetch circuit of claim 1, wherein:
the at least one first dedicated prefetch policy is comprised of a first dedicated prefetch policy;
the at least one second dedicated prefetch policy is comprised of a second dedicated prefetch policy; and
the prefetch filter is configured to select the prefetch policy from among the at least one first dedicated prefetch policy and the at least one second dedicated prefetch policy, based on the at least one miss state of the miss tracking circuit.

4. The adaptive cache prefetch circuit of claim 3, wherein:
the first dedicated prefetch policy is comprised of a never prefetch policy; and
the second dedicated prefetch policy is comprised of an always prefetch policy.

5. The adaptive cache prefetch circuit of claim 1, wherein the miss tracking circuit is comprised of at least one miss counter, and the at least one miss state is comprised of at least one miss count;
the at least one miss counter configured to update the at least one miss count based on the cache miss resulting from the accessed cache entry in the at least one first dedicated cache set and the at least one second dedicated cache set; and
the prefetch filter configured to select the prefetch policy from among the at least one first dedicated prefetch policy and the at least one second dedicated prefetch policy, based on the at least one miss count of the at least one miss counter.

6. The adaptive cache prefetch circuit of claim 1, wherein the miss tracking circuit is comprised of a miss saturation indicator and the at least one miss state is comprised of a miss state,
the miss saturation indicator configured to update the miss state based on the cache miss resulting from the accessed cache entry in the at least one first dedicated cache set and the at least one second dedicated cache set; and
the prefetch filter configured to select the prefetch policy from among the at least one first dedicated prefetch policy and the at least one second dedicated prefetch policy, based on the miss state of the miss saturation indicator.

7. The adaptive cache prefetch circuit of claim 6, wherein the miss saturation indicator is comprised of a miss saturation counter and the miss state is comprised of a miss saturation count;
the miss saturation counter configured to update the miss saturation count based on the cache miss resulting from the accessed cache entry in the at least one first dedicated cache set and the at least one second dedicated cache set; and
the prefetch filter configured to select the prefetch policy from among the at least one first dedicated prefetch policy and the at least one second dedicated prefetch policy, based on the miss saturation count of the miss saturation counter.

8. The adaptive cache prefetch circuit of claim 7, wherein the miss saturation counter is configured to update the miss saturation count by being configured to:
update the miss saturation count by incrementing or decrementing the miss saturation count, based on the cache miss resulting from the accessed cache entry in the at least one first dedicated cache set in the cache for which the at least one first dedicated prefetch policy is applied; and
update the miss saturation count by decrementing or incrementing the miss saturation count, respectively, based on the cache miss resulting from the accessed cache entry in the at least one second dedicated cache set in the cache for which the at least one second dedicated prefetch policy, different from the at least one first dedicated prefetch policy, is applied.

9. The adaptive cache prefetch circuit of claim 1, wherein the miss tracking circuit is comprised of a plurality of miss indicators each comprising a miss state, each of the plurality of miss indicators associated with a dedicated cache set among the at least one first dedicated cache set and the at least one second dedicated cache set;
the plurality of miss indicators each further configured to update the associated miss state based on the cache miss resulting from the accessed cache entry in the dedicated cache set among the at least one first dedicated cache set and the at least one second dedicated cache set in the cache; and
the prefetch filter configured to select the prefetch policy from among the at least one first dedicated prefetch policy and the at least one second dedicated prefetch policy, based on a comparison of the at least one miss state in the plurality of the miss indicators.

10. The adaptive cache prefetch circuit of claim 1, wherein the prefetch filter is further configured to selectively not select the prefetch policy from among the at least one first dedicated prefetch policy and the at least one second dedicated prefetch policy, based on the at least one miss state of the miss tracking circuit.

11. The adaptive cache prefetch circuit of claim 7, wherein the prefetch filter is further configured to selectively not select the prefetch policy from among the at least one first dedicated prefetch policy and the at least one second dedicated prefetch policy, to be applied to the prefetch request issued by the prefetch control circuit based on at least one significant bit in the miss saturation count of the miss saturation counter.

12. The adaptive cache prefetch circuit of claim 1, wherein the prefetch filter is further configured to always not select the at least one first dedicated prefetch policy or the at least one second dedicated prefetch policy.

13. The adaptive cache prefetch circuit of claim 1, wherein the prefetch filter is further configured to:
probabilistically determine if the at least one first dedicated prefetch policy or the at least one second dedicated prefetch policy, should be applied to a prefetch request issued by a prefetch control circuit based on the at least one miss state of the miss tracking circuit; and
select the at least one first dedicated prefetch policy or the at least one second dedicated prefetch policy, to be applied to the prefetch request issued by the prefetch control circuit, based on the probabilistic determination.

14. The adaptive cache prefetch circuit of claim 1, wherein:
the cache comprising a plurality of cache sets each configured to store one or more cache entries, the plurality of cache sets comprising:
the at least one first dedicated cache set configured to receive prefetched cache data based on the at least one first dedicated prefetch policy;
the at least one second dedicated cache set configured to receive the prefetched cache data based on the at least one second dedicated prefetch policy; and
at least one follower cache set configured to receive the prefetched cache data based on either the at least one first dedicated prefetch policy or the least one second dedicated prefetch policy;
a cache controller configured to receive a memory access request comprising a memory address and determine if a cache entry corresponding to the memory address is contained in the cache; and
a prefetch control circuit configured to issue a prefetch request to prefetch the prefetched cache data into the plurality of cache sets in the cache according to the prefetch policy.

15. The adaptive cache prefetch circuit of claim 14, wherein the prefetch filter is disposed outside of the cache controller.

16. The adaptive cache prefetch circuit of claim 14, wherein the cache controller comprises the prefetch filter

17. The adaptive cache prefetch circuit of claim 1 disposed into an integrated circuit (IC).

18. The adaptive cache prefetch circuit of claim 1 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

19. An adaptive cache prefetch circuit for prefetching cache data into a cache, comprising:
a miss tracking means for updating at least one miss state means based on a cache miss resulting from an accessed cache entry in: at least one first dedicated cache set in a cache for which at least one first dedicated prefetch policy is applied, and at least one second dedicated cache set in the cache for which at least one second dedicated prefetch policy, different from the at least one first dedicated prefetch policy, is applied; and
a prefetch filter means for selecting a prefetch policy from among the at least one first dedicated prefetch policy and the at least one second dedicated prefetch policy based on the at least one miss state means of the miss tracking means.

20. A method of adaptive cache prefetching based on competing dedicated prefetch policies in dedicated cache sets, comprising:
receiving a memory access request comprising a memory address to be addressed in a cache;
determining if the memory access request is a cache miss by determining if an accessed cache entry among a plurality of cache entries in the cache corresponding to the memory address, is contained in the cache;
updating at least one miss state of a miss tracking circuit based on the cache miss resulting from the accessed cache entry in: at least one first dedicated cache set in the cache for which at least one first dedicated prefetch policy is applied, and at least one second dedicated cache set in the cache for which at least one second dedicated prefetch policy, different from the at least one first dedicated prefetch policy, is applied;
issuing a prefetch request to prefetch cache data into a cache entry in a follower cache set among a plurality of cache sets in the cache;
selecting a prefetch policy from among the at least one first dedicated prefetch policy and the at least one second dedicated prefetch policy, to be applied to the prefetch request, based on the at least one miss state of the miss tracking circuit; and
filling the prefetched cache data into the cache entry in the follower cache set based on the selected prefetch policy.

21. The method of claim 20, wherein updating the miss tracking circuit comprises:
updating the at least one miss state of the miss tracking circuit based on the cache miss resulting from the accessed cache entry to the at least one first dedicated cache set in the cache, for which a never prefetch policy is applied; and
updating the at least one miss state of the miss tracking circuit based on the cache miss resulting from the accessed cache entry to the at least one second dedicated cache set in the cache, for which an always prefetch policy is applied.

22. The method of claim 20, wherein:
updating the at least one miss state of the miss tracking circuit comprises updating at least one miss count of at least one miss counter based on the cache miss resulting from the accessed cache entry in: the at least one first dedicated cache set in the cache, for which the at least one first dedicated prefetch policy is applied, and the at least one second dedicated cache set in the cache, for which the at least one second dedicated prefetch policy, different from the at least one first dedicated prefetch policy, is applied; and
selecting the prefetch policy comprises selecting the prefetch policy from among the at least one first dedicated prefetch policy and the at least one second dedicated prefetch policy, to be applied to the prefetch request, based on the at least one miss count of the at least one miss counter.

23. The method of claim 22, wherein:
updating the at least one miss count of the at least one miss counter comprises updating at least one miss saturation count of at least one miss saturation counter, based on the cache miss resulting from the accessed cache entry in: the at least one first dedicated cache set in the cache for which the at least one first dedicated prefetch policy is applied, and the at least one second dedicated cache set in the cache, for which the at least one second dedicated prefetch policy, different from the at least one first dedicated prefetch policy, is applied; and
selecting the prefetch policy comprises selecting the prefetch policy from among the at least one first dedicated prefetch policy and the at least one second dedicated prefetch policy, to be applied to the prefetch request, based on the at least one miss saturation count of the at least one miss saturation counter.

24. The method of claim 23, wherein updating the at least one miss saturation count of the at least one miss saturation counter, comprises:
incrementing or decrementing the at least one miss saturation count of the at least one miss saturation counter, based on the cache miss resulting from the accessed cache entry in the at least one first dedicated cache set in the cache for which the at least one first dedicated prefetch policy is applied; and
decrementing or incrementing, respectively, the at least one miss saturation count of the at least one miss saturation counter, based on the cache miss resulting from the accessed cache entry in the at least one second dedicated cache set in the cache for which the at least one second dedicated prefetch policy, different from the at least one first dedicated prefetch policy, is applied.

25. The method of claim 20, further comprising ignoring the at least one first dedicated prefetch policy as the selected prefetch policy or the at least one second dedicated prefetch policy as the selected prefetch policy.

26. The method of claim 20, further comprising probabilistically determining if the at least one first dedicated prefetch policy or the at least one second dedicated prefetch policy should be selected as the selected prefetch policy;
wherein filling the prefetched cache data comprises filling the prefetched cache data into the cache entry in the follower cache set based on the probabilistically determined prefetch policy.

27. A non-transitory computer-readable medium having stored thereon computer executable instructions to cause a processor-based adaptive cache prefetch circuit to prefetch cache data into a cache, by:
updating at least one miss state of a miss tracking circuit based on a cache miss resulting from an accessed cache entry in: at least one first dedicated cache set in a cache for which at least one first dedicated prefetch policy is applied, and at least one second dedicated cache set in the cache for which at least one second dedicated prefetch policy, different from the at least one first dedicated prefetch policy, is applied; and
selecting a prefetch policy from among the at least one first dedicated prefetch policy and the at least one second dedicated prefetch policy, to be applied in a prefetch request issued by a prefetch control circuit to cause the cache to be filled, based on the at least one miss state of the miss tracking circuit.

28. The non-transitory computer-readable medium of claim 27 having stored thereon the computer executable instructions to cause the processor-based adaptive cache prefetch circuit to prefetch cache data into the cache by updating the at least one miss state of the miss tracking circuit by:
updating the at least one miss state of the miss tracking circuit based on the cache miss resulting from the accessed cache entry to the at least one first dedicated cache set in the cache, for which a never prefetch policy is applied; and
updating the at least one miss state of the miss tracking circuit based on the cache miss resulting from the accessed cache entry to the at least one second dedicated cache set in the cache for which an always prefetch policy is applied.

29. The non-transitory computer-readable medium of claim 27 having stored thereon the computer executable instructions to cause the processor-based adaptive cache prefetch circuit to prefetch cache data into the cache by ignoring the at least one first dedicated prefetch policy as the selected prefetch policy or the at least one second dedicated prefetch policy as the selected prefetch policy.
